(19) United States
(12) Patent Application Publication
(10) Pub. No.: US 2010/0305918 A1
(43) Pub. Date: Dec. 2, 2010

(54) Ground-Coupled Heat Exchange for Heating and Air Conditioning Applications

(75) Inventor: Kent Stewart Udell, Salt Lake City, UT (US)

Correspondence Address: THORPE NORTH & WESTERN, LLP., P.O. Box 1219, SANDY, UT, 84091-1219, US

(73) Assignee: UNIVERSITY OF UTAH RESEARCH FOUNDATION, Salt Lake City, UT (US)

(21) Appl. No.: 12/742,080

(22) PCT Filed: Nov. 7, 2008
(86) PCT No.: PCT/US08/82798

§ 371 Date: Jul. 28, 2010

Related U.S. Application Data
(60) Provisional application No. 60/986,243, filed on Nov. 7, 2007.

(51) Int. Cl. G06F 17/50; F28D 15/02; F28F 13/00; F24J 3/08; F25B 29/00; G06F 17/10

(52) U.S. Cl. 703/2; 165/104.21; 165/135; 165/45; 165/61

(57) ABSTRACT

The invention provides systems and methods for cooling and/or heating a structure. Generally, a system for heating or cooling a structure can include at least one thermosiphon in thermal communication with a thermal storage material such as a volume of earth. The thermosiphon can be partially filled with a heat transfer fluid and a heat exchanger operatively connected to the thermosiphon which is in thermal communication with the structure. Thermal energy can be transferred between the thermal storage material and the structure in either a passive or assisted mode, depending on whether the system is charging or in use.

### FIELD OF THE INVENTION

The present invention relates generally to ground-coupled thermosiphons. More particularly, the present invention relates to methods and systems of heating and cooling a structure using ground-coupled thermosiphons. As such, the present invention relates to the fields of geothermal engineering, thermodynamics, and material science.

### BACKGROUND OF THE INVENTION

Heating and air conditioning systems are needed throughout the world but are frequently energy intensive and cost prohibitive. Such systems can typically cost on the order of thousands of dollars for residential systems, and even more for commercial spaces. Additionally, they generally require a great deal of energy to obtain satisfactory performance adding to the cost and further burdening the energy resources of communities. Generally, heating and cooling costs can run upwards of 75% of a building's total utility cost annually and by some estimates account for upwards of 45% of total energy usage. Other costs associated with such systems include filters, regular maintenance, and replacement of expensive parts, e.g., compressors.

Systems and methods have been developed for reducing these costs. For example, the cleaning of heat transfer components has been used to maximize the transfer of energy, novel materials have been used to increase efficiency, and systems have been designed to use alternate sources of fuel in efforts to decrease dependency on gas and/or electricity.

For many decades, ground-coupled heat pumps have been used to circulate fluids through several intermediary heat exchangers and extensive plastic piping which is embedded in the ground. In this way, cooler ground temperatures can be used to cool a fluid and ultimately an environment. However, these systems require constant pumping of fluids through the system and have non-optimal heat transfer coupling between the pipes and surround soil. Further, vertical borehole systems utilize adjacent hot and cold tubes which results in some short-circuiting of heat and reduction in efficiencies.

At the present time, the development of improved heating and cooling systems, by either improving existing systems or discovering new materials that meet all desirable requirements for practical applications, remains a complex and challenging task.

### SUMMARY OF THE INVENTION

It has been recognized that it would be advantageous to develop a heating and air-conditioning system with minimal energy requirements which is also cost effective. In one embodiment, a system for heating or cooling a structure can include a thermosiphon in thermal communication with a thermal storage material. The thermosiphon can be partially filled with a heat transfer fluid such that both liquid and vapor phases are present. A heat exchanger can be operatively connected to the thermosiphon and be in thermal communication with the structure such that thermal energy can be transferred between the thermal storage material and the structure. A fluid transfer device can be fluidly associated with the heat transfer fluid and configured to draw the heat transfer fluid towards the heat exchanger.

In one embodiment, the thermosiphon can further comprise an evaporating region and a condensing region, where the heat transfer fluid is present in both a liquid and vapor phase. The thermosiphon can be in thermal communication with the thermal storage material such that the heat transfer fluid is capable of transferring energy between the thermal storage material and the evaporating region and/or the condensing region.

Optionally, the system can further comprise a secondary storage area operatively connected in a by-pass configuration to the heat exchanger, where the fluid transfer device transfers the heat transfer fluid from the thermosiphon to the secondary storage area. In another optional embodiment, the system can further comprise a second fluid transfer device fluidly connected between the secondary storage area and the heat exchanger.

The thermosiphon can be exposed to ambient air in order to enhance heat transfer into or out of the thermosiphon. In one embodiment, the heatsink can be a cooling reservoir such that the heat exchanger can be an evaporator when operating as a cooling system. Alternatively, or in combination, the system can be configured to heat the structure and the heat exchanger can be a heat radiator.

In one specific embodiment, a system for cooling and heating a structure can comprise a cooling system in thermal communication with the structure. The cooling system comprises a first thermosiphon in thermal communication with a first thermal storage material, where the first thermosiphon is partially filled with a first heat transfer fluid. The cooling system can also comprise a first heat exchanger operatively connected to the first thermosiphon and is in thermal communication with the structure such that thermal energy can be transferred between the first thermal storage material and the structure. A first fluid transfer device can be fluidly associated with the first heat transfer fluid and configured to draw the first heat transfer fluid towards the first heat exchanger. The system can also include a heating system in thermal communication with the structure. The heating system comprises a second thermosiphon in thermal communication with a second thermal storage material, where the second thermosiphon is partially filled with a second heat transfer fluid. The heating system can also include a second heat exchanger operatively connected to the second thermosiphon and in thermal communication with the structure such that thermal energy can be transferred between the second thermal storage material and the structure. A second fluid transfer device can be fluidly associated with the second heat transfer fluid and configured to transfer the second heat transfer fluid within the second thermosiphon.

The first and second thermosiphons can further comprise evaporating regions and condensing regions, where the first and second heat transfer fluids are present in a liquid and vapor phase, and are in communication with the first and second thermal storage materials, respectively, such that the first and second heat transfer fluids are capable of transferring energy between the first and second thermal storage materials and the evaporating regions or the condensing regions, respectively.

A method of energy transfer between a structure and outside the structure can comprise charging a thermal storage material by forming a thermal gradient between the structure and the thermal storage material using a thermal transfer fluid; and transferring thermal energy between the structure and the thermal storage material using a thermosiphon containing the thermal transfer fluid, where at least one of the steps of charging and transferring is augmented using a fluid transfer device.

Charging the thermal storage material can occur during winter months thereby creating a cooling reservoir, and transferring thermal energy from the structure to the cooling reservoir results in cooling the structure. Similarly, charging the thermal storage material can occur during summer months thereby creating a heating reservoir, and transferring thermal energy from the heating reservoir to the structure results in heating the structure.

### BRIEF DESCRIPTION OF THE DRAWINGS

FIG. 1 is a schematic of a thermosiphon coupled to the ground in accordance with an embodiment of the present invention.

FIG. 2 is a schematic of a heating or cooling system in accordance with an embodiment of the present invention.

FIG. 3 is a schematic of a heating or cooling system including a charging heat exchanger and a heating/cooling heat exchanger in accordance with one embodiment of the present invention.

These figures merely depict exemplary embodiments of the present invention and they are, therefore, not to be considered limiting of its scope. Furthermore, dimensions in particular are not necessarily to scale or accurately proportioned, but are modified for sake of clarity and explanation of the invention. It will be readily appreciated that the components of the present invention, as generally described and illustrated in the figures herein, could be arranged, sized, and designed in a wide variety of different configurations.

### DETAILED DESCRIPTION

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

It must be noted that, as used in this specification and the appended claims, the singular forms “a,” “an,” and “the” include plural referents unless the context clearly dictates otherwise. Thus, for example, reference to “a heat transfer fluid” includes one or more of such materials, reference to “a pump” includes reference to one or more of such devices, and reference to “a heating step” includes reference to one or more of such steps.

### DEFINITIONS

In describing and claiming the present invention, the following terminology will be used in accordance with the definitions set forth below.

As used herein, “thermosiphon” refers to the method of passive heat exchange based on natural convection which circulates a liquid/vapor mixture in a vertical closed-loop circuit. Even though, generally, such a term infers no need of a pump, or other fluid transfer device, the thermosiphons described herein may, or may not, be used with such devices. When liquid is heated at a location (either end of the thermosiphon), the liquid is vaporized at a rate proportional to the heating rate. The vapor then flows to any location where the pipe is cooled as a result of temperature induced pressure gradients. Condensed liquid then flows via gravity towards the warmer heat end, i.e. the condenser is oriented above the heat source end. Thus a passive, unassisted, operation can occur when transferring heat from a heated soil to a structure (heating mode in use) or cooling of soil (cooling mode during charging). In a “pump assisted” or “charging” mode, a fluid transfer device can be used to drive heat in the opposite direction as described in more detail below.

As used herein, “summer” refers generally to a period of time associated with highest average temperatures for a given location and is often approximately three months. Even though this term has generally been defined as a three-month period throughout the world, summer may include more than or less than three months determined upon the locale. For example, an environment that maintains an average temperature of at least 27° C. for any given month may be considered to be a “summer” month.

As used herein, “winter” refers to an approximate three-month period of time in a calendar year where a local environment generally reaches its lowest mean temperature for the three-month period. Even though this term has generally been defined as a three-month period throughout the world, winter may include more than or less than three months determined upon the locale.

As used herein, “substantial” refers to a quantity or amount of a material, or a specific characteristic thereof, that is sufficient to provide an effect that the material or characteristic was intended to provide. The exact degree of deviation allowable may in some cases depend on the specific context. Similarly, “substantially free of” or the like refers to the lack of an identified element or agent in a composition. Particularly, elements that are identified as being “substantially free of” are either completely absent from the composition, or are included only in amounts which are small enough so as to have no measurable effect on the composition.

As used herein, the term “about” is used to provide flexibility to a numerical range endpoint by providing that a given value may be “a little above” or “a little below” the endpoint. The degree of flexibility of this term can be dictated by the particular variable and would be within the knowledge of those skilled in the art to determine based on experience and the associated description herein.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited.

As an illustration, a numerical range of “about 10 to about 50” should be interpreted to include not only the explicitly recited values of about 10 to about 50, but also include individual values and sub-ranges within the indicated range. Thus, included in this numerical range are individual values such as 20, 30.5, and 40 and sub-ranges such as from 10-30, from 20-40, and from 30-50, etc. This same principle applies to ranges reciting only one numerical value. Furthermore, such an interpretation should apply regardless of the breadth of the range or the characteristics being described.

### Embodiments of the Invention

The present invention provides heating and air-conditioning systems requiring minimal electricity. Such systems generally use thermosiphons that can charge a material forming a heating or cooling reservoir and then use such reservoirs to heat or cool an enclosed structure.

In one embodiment, a system for heating or cooling a structure can comprise a thermosiphon in thermal communication with a thermal storage material, where the thermosiphon is partially filled with a heat transfer fluid; a heat exchanger operatively connected to the thermosiphon and in thermal communication with the structure such that thermal energy can be transferred between the thermal storage material and the structure; and a fluid transfer device fluidly associated with the heat transfer fluid and configured to draw the heat transfer fluid towards the heat exchanger.

The thermal storage material generally can comprise an amount of earth or soil and in many cases will be native undisturbed soil and earth. As such, the systems described herein can be used with various types of soils, including those listed in the World Soil Classification developed by the Food and Agriculture Organization of the United Nations (FAO) and World Reference Base for Soil Resources developed by an international collaboration coordinated by the International Soil Reference and Information Centre (ISRIC) and sponsored by the IUSS and the FAO via its Land & Water Development division. Such soils include without limitation Acrisol, Albeluvisol, Alisol, Andosol, Anthrosol, Arenosol, Calcisol, Cambisol, Chernozem, Cryosol, Durisol, Ferralsol, Fluvisol, Gleysol, Gypsisol, Histosol, Kastanozem, Leptosol, Lixisol, Luvisol, Nitisol, Phaeozem, Planosol, Plinthosol, Podzol, Regosol, Solonchak, Solonetz, Umbrisol, Vertisol, and mixtures thereof. Although, the systems described herein can be used with local soils found throughout the world, other materials can also be used. For example, the thermal storage material can be water. Typically the storage material can be a defined volume of earth, although other materials can be specially prepared (e.g. excavated and back-filled with an appropriate bulk material or liquid water). In one embodiment, materials that can be used include those having a heat capacity of at least about 1 kJ/kg-K. In one embodiment, the heat capacity can be 5 kJ/kg-K.

Generally, the thermosiphons described herein can further comprises an evaporating region and a condensing region, where a heat transfer fluid is present in a liquid and vapor phase, and is in thermal communication with the thermal storage material such that the heat transfer fluid is capable of transferring energy between the thermal storage material and the evaporating region or the condensing region. As such, the heat transfer fluid can be selected from the group consisting of water, R134a, R-22, R-744, sodium, liquefied propane gas, C1-C6 alcohols, ethanol, ammonia, condensed hydrocarbon gases, and mixtures thereof. In one embodiment, the heat transfer fluid can have an enthalpy of vaporization of about 200 kJ/kg to about 4000 kJ/kg, and often from about 500 kJ/kg to about 2500 kJ/kg. In another embodiment, the heat transfer fluid can be a fluid having a vapor pressure within 0.2 MPa to 4 MPa (e.g. R-134a) between a temperature range of about −10° C. to about 102° C.

The thermosiphons can be installed by conventional or unconventional boring approaches such as but not limited to, direct push (hydraulic press), self-propelled drilling heads, vertical drilling bore heads, and the like. The outer diameter of these thermosiphons can be designed for a particular installation; however diameters can generally range from about 1 inch to about 6 inches, with 2 to 4 inches often representing a good balance of high performance and reduced installation cost. For example, one embodiment can include a 4 inch diameter thermosiphon at a depth of 50 to 150 feet which can effectively perform using a 30 W pump.

In addition to the fluid transfer device thus described, the thermosiphons described herein can contain a separate fluid transfer device fluidly associated with the heat transfer fluid and configured to transfer the heat transfer fluid between the evaporation and condensation areas of the thermosiphon that are associated with the charging of the thermal storage material. In the case of water as the fluid, water vapor pressures can be subatmospheric for temperatures below 100° C. The fluid transfer device can be any device that is configured to transfer fluid within the heating and/or cooling system. In one embodiment, the fluid transfer device can be a fluid pump such as a membrane pump. However, any suitable fluid pump can be used.

Generally, the heat exchanger can be any device that allows the transfer of heat. In one embodiment, the heat exchanger can be an evaporator. In another embodiment, the heat exchanger can be a heat radiator. Such heat exchangers can be coupled to forced air systems as is known in the art. The structure which can be heated and/or cooled can generally be a building such as an office building, warehouse, residential home, or the like. However, other structures can also benefit from coupling to the system of the present invention. For example, the use heat exchanger can be coupled to a refrigerator in order to supplement or replace a conventional compressor-driven thermal cooling cycle, e.g. the use heat exchanger can be thermally connected to the refrigerator compartment in the same manner as conventional refrigeration coils.

Typically, the thermosiphons described herein can be used to charge a thermal storage material during a specific period of time and then be used to heat or cool a structure during another specific period of time. For example, a thermosiphon can be coupled to the ground thereby charging a volume of earth during the winter in a passive mode forming a cooling reservoir. The cooling reservoir can then be used to cool a structure during the summer via a heat exchanger operatively coupled to the thermosiphon in a pump-assist mode. Similarly, a separate or common thermosiphon can be coupled to the ground which is used by charging a volume of earth during the summer forming a heating reservoir. The heating reservoir can then be used to passively heat a structure during the summer via a heat exchanger operatively coupled to the thermosiphon. Cooling and heating reservoirs can be completely remote from one another, i.e. having substantially no heat transfer between them, or may be arranged to minimize disturbance of the other during operation in a limited volume, e.g. by orienting the cooling reservoir above the heating reservoir. For example, the reservoirs can be separated by a distance of at least 2 meters to reduce heat transfer between the reservoirs. Depending on the particular temperatures and conditions, the passive modes may require pump assistance in order to provide a desired heat transfer rate. For example, if soil temperature drops below about 24-25° C. a small pump may be used to increase fluid flow rates from the heat reservoir to the heat exchanger.

In one embodiment, the system can further comprise a secondary storage area operatively connected in a by-pass configuration to a heat exchanger, where the fluid transfer device transfers the heat transfer fluid from the thermosiphon to the secondary storage area. The secondary storage area can acts as a vapor trap. In this case, the system can further comprise a second fluid transfer device fluidly connected between the secondary storage area and the heat exchanger. The second fluid transfer device can transfer fluid from the secondary storage device to the heat exchanger.

Generally, the thermosiphon can be exposed to ambient air. Such exposure can be used as an efficient and effective means of charging a thermal material using the local environmental conditions. As such, the thermosiphon can further comprise an expanded surface area section enabling more effective and efficient energy transfer. Such expanded area can be fashioned in an aesthetically pleasing shape. For example, the expanded surface area section can be a fence, wall, posts, decking, roof, panels, combinations of these, or the like. Further, the charging heat exchanger can optionally include photo-voltaic/thermal (PVT) panels, solar thermal collectors, heat exchange panels, or other suitable heat collection devices. Photo-voltaic/thermal (PVT) panels may optionally include porous, high surface area materials which allow for increased gas/liquid contact surface area.

As previously discussed, the thermal storage material can be a heatsink having the ability to be a heating reservoir or cooling reservoir. In one embodiment, the thermal storage material or heatsink can be a cooling reservoir having an effective heat capacity sufficient for a total heat storage from about 10,000,000 kJ to about 100,000,000 kJ. In another embodiment, the thermal storage material or heatsink can be a heating reservoir having an effective heat capacity sufficient for a total heat storage from about 30,000,000 kJ to about 300,000,000 kJ. The systems described herein can significantly reduce the amount of conventional energy, e.g., electricity, needed to heat and/or cool a structure. In one embodiment, the system can use less than about 0.10 kW-hrs of electricity per day. In another embodiment, the system can use less than about 0.050 kW-hrs of electricity per day. In yet another embodiment, the system can use less than about 0.025 kW-hrs of electricity per day. Although the energy requirements can vary per the particular design, the system may generally use from 0.1 kW-hr to 10 kW-hr of electricity per day depending on fan, compression, and pumping power demands of each design.

Although, the systems described herein can be discrete, i.e., an independent heating or cooling system, such systems can be combined to heat and cool a structure. As such, in one embodiment, a system for cooling and heating a structure can comprise: a) a cooling system in thermal communication with the structure, where the cooling system comprises 1) a first thermosiphon in thermal communication with a first thermal storage material, where the first thermosiphon is partially filled with a first heat transfer fluid; 2) a first heat exchanger operatively connected to the first thermosiphon and in thermal communication with the structure such that thermal energy can be transferred between the first thermal storage material and the structure; and 3) a first fluid transfer device fluidly associated with the first heat transfer fluid and configured to draw the first heat transfer fluid towards the first heat exchanger; and b) a heating system in thermal communication with the structure, where the heating system comprises 1) a second thermosiphon in thermal communication with a second thermal storage material, where the second thermosiphon is partially filled with a second heat transfer fluid; 2) a second heat exchanger operatively connected to the second thermosiphon and in thermal communication with the structure such that thermal energy can be transferred between the second thermal storage material and the structure; and 3) a second fluid transfer device fluidly associated with the second heat transfer fluid and configured to transfer the second heat transfer fluid within the second thermosiphon.

In one embodiment, the first and second thermosiphons can further comprise evaporating regions and condensing regions, where the first and second heat transfer fluids are present in a liquid and vapor phase, and are in communication with the first and second thermal storage materials, respectively, such that the first and second heat transfer fluids are capable of transferring energy between the first and second thermal storage materials and the evaporating regions or the condensing regions, respectively.

In one embodiment, a method of energy transfer between a structure and outside the structure can comprise charging a thermal storage material by forming a thermal gradient between the structure and the thermal storage material using a thermal transfer fluid; and transferring thermal energy between the structure and the thermal storage material using a thermosiphon containing the thermal transfer fluid, where at least one of the steps of charging and transferring is augmented using a fluid transfer device.

The first and second heat transfer fluids can be the same or different. The thermosiphons can have the same of different fluid capacities. Additionally, the thermosiphons described herein can be of various sizes and can be tailored to achieve various energy transfer thresholds.

The present systems can be used in various types of structures including, without limitation, residential and commercial. Examples of such structures include, without limitation, houses, apartments, office buildings, business complexes, warehouses, etc.

The present systems can use open or closed thermosiphons. An open thermosiphon can be perforated at one end of the thermosiphon such that the heat transfer fluid is in direct contact with a fluid source external to the thermosiphon.

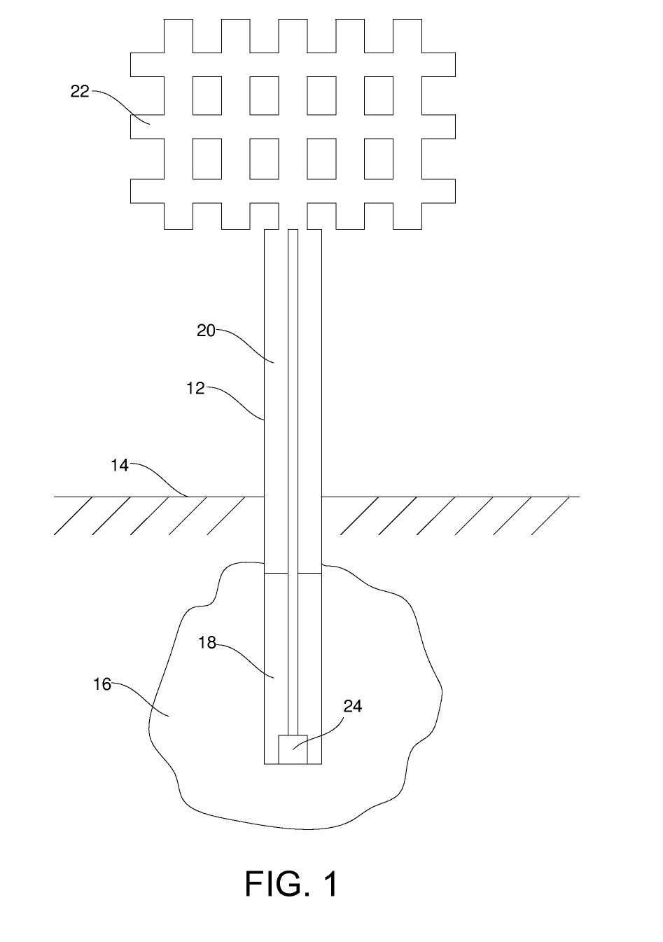

Turning now to FIG. 1, a thermosiphon 12 is coupled to a soil 14 such as by embedding within the soil. The soil 14 can provide a suitable thermal storage material as described herein. The thermosiphon 12 can form a heatsink 16 during either the summer or winter as previous discussed. The thermosiphon can further comprise a heat transfer fluid in a liquid phase 18 and vapor phase 20. As a general rule, the depth of the thermosiphon can be sufficient to isolate the reservoir from above ground temperature fluctuations or other thermal sources while also avoiding unnecessary depth which increases costs and potential heat transfer losses. Depths can vary depending on the particular composition of the ground, ground water velocity, permeability, and other factors; however depths from about 40 feet to about 300 feet can often be suitable.

In one aspect, the heat transfer fluid liquid phase 18 can be transferred to an expanded surface area 22 via a fluid transfer device 24. The heat transfer fluid liquid phase can absorb energy thereby vaporizing the heat transfer fluid forming the heat transfer fluid vapor phase 20. Such heat transfer fluid vapor phase 20 can then condense on the walls of the thermosiphon 12 and pass down into the liquid phase transferring the captured heat into the fluid and ultimately the surrounding soil outside the thermosiphon due to a temperature gradient between the liquid and the surrounding soil. As heat is transferred in this manner, a heat sink 16 is formed as a heating reservoir. Thus, a soil having a high heat capacity and relatively low thermal conductivity can retain a sufficient amount of heat within the volume surrounding the lower end of a grouping of thermosiphons to heat the associated structure or dwelling throughout the winter. This is an issue of the volume of heated soil to the area of the bounds of the heated soil such that a group of thermosiphons can be used to provide sufficient capacity. Furthermore, the systems of the present invention operate under conditions where heat transfer predominantly occurs via phase changes of the heat transfer fluid.

Alternately, in another aspect, the heat transfer fluid in the liquid phase 18 can absorb latent heat from the soil 14 thereby vaporizing the heat transfer fluid forming the heat transfer fluid vapor phase 18. The heat transfer fluid vapor phase 18 can then transfer energy by condensation in the expanded surface area 22 and subsequently flowing back to the bottom of the thermosiphon 12 forming the heatsink 16 as a cooling reservoir. Notably, no fluid transfer device is needed in this aspect, although such may be used to further augment heat transfer away from the cooling reservoir. For example, a solar powered pump could be used which is only activated when desired in order to transport fluid to the expanded surface area. Furthermore, an optional freeze control mechanism can be implemented to avoid freezing the heat transfer fluid. Such a mechanism can include the use of a heat transfer fluid with a freezing point well below expected lowest air temperatures.

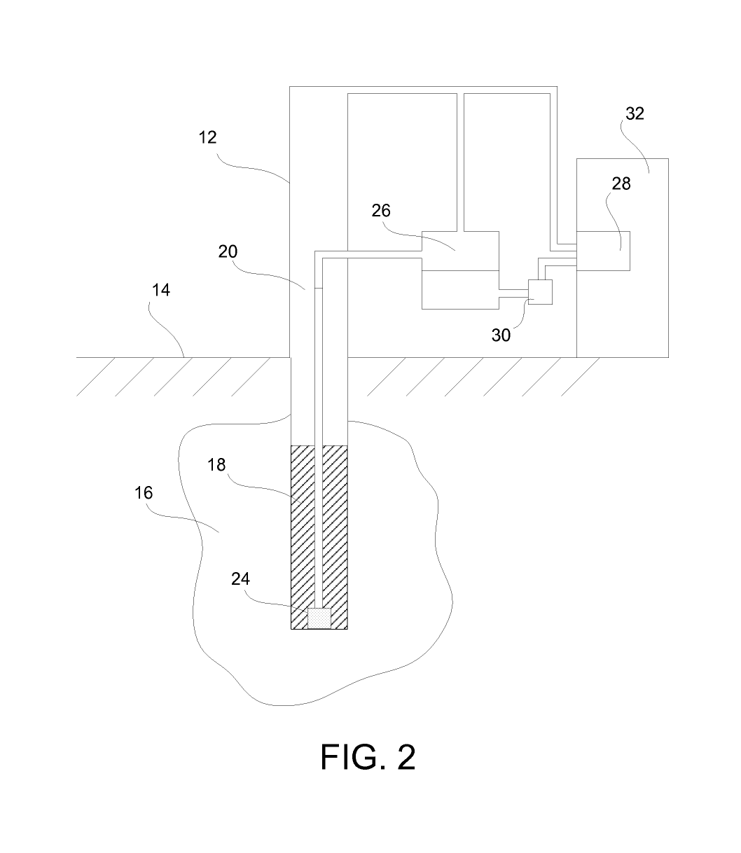

In another optional aspect of the present invention, turning now to FIG. 2 a thermosiphon 12 is coupled to a soil 14. The soil 14 can be a thermal storage material as previously described. The thermosiphon 12 can form a heatsink 16 during either the summer or winter as previous discussed. The thermosiphon can further comprise a heat transfer fluid in a liquid phase 18 and vapor phase 20 in a similar manner as before. A secondary storage area 26 can be operatively connected in a by-pass configuration to a heat exchanger 28, where the fluid transfer device 24 transfers the heat transfer fluid in the liquid phase 18 from the thermosiphon 12 to the secondary storage area 26. The secondary storage area can act as a vapor trap and holding vessel. As such, the system can further comprise a second fluid transfer device 30 fluidly connected between the secondary storage area and the heat exchanger. The second fluid transfer device can transfer the heat transfer fluid in the liquid phase 18 from the secondary storage area 26 to the heat exchanger. The heat exchanger can enable energy transfer from the structure 32 to the cold heat transfer fluid 18 in order to cool an environment within the structure. For example, air can be passed across the cold heat transfer fluid and/or an associated pipe or member of the heat transfer unit to cool the air. The cooled air can be conveyed by force convection or natural convection, depending on the configuration of the system. In one aspect, the energy transfer can result in vaporization of the transfer fluid forming heat transfer fluid vapor phase 20, although a substantially all liquid process could also affect cooling in the heat exchanger. The heat transfer fluid vapor phase 20 can then condense along the walls of the thermosiphon 12 reforming the heat transfer fluid in the liquid phase 18 which is then available to transfer energy from the heatsink 16 as part of a cyclic process. Conduits between the thermosiphon and the heat exchanger can be insulated in order to reduce heat losses, especially along paths between the thermosiphon and the structure.

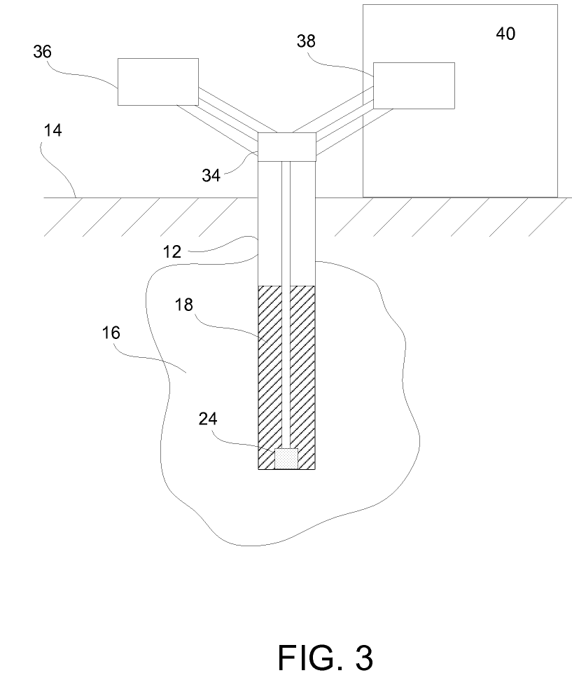

In each of the cooling and heating systems, a first heat exchanger can function to charge the thermal storage material while a second heat exchanger can be provided to transfer heat with the structure. For example, the system shown in FIG. 1 can be effectively used to store heat in the thermal storage material. However, during winter months when the heat is transferred to the structure, the heat exchanger must either be moved into the structure from an external location or a secondary heat exchanger can be operatively connected to the system to allow heating during the winter. FIG. 3 illustrates one embodiment of a system which can be used to both charge and heat or cool. In this embodiment, a heat transfer barrier system 34 can be operatively connected between the thermal storage material 16 and each of the use heat exchanger 38 and the charging heat exchanger 36. The heat transfer barrier system can selectively direct heat transfer to or from either of the heat exchanger and the charging heat exchanger. Non-limiting examples of suitable barrier systems can include solenoids, valves, switches and the like. In this manner, during charging, the heat exchanger within the structure can be at least partially, if not substantially, isolated from heat transfer between the charging heat exchanger and the heat storage material. Similarly, during use, the charging heat exchanger can be substantially isolated from the heat transfer between the active use heat exchanger and the heat storage material. Thus, effective seasonal underground thermal energy storage can be achieved to both heat and cool a structure.

In summary, four basic modes of operation of this system can include two heating modes and two cooling modes. The heating modes include a first pump-assisted charging mode where heat is collected at the heat exchanger and transferred to the soil. A second use heating mode includes transferring heat from the soil to the heat exchanger for distribution into the structure. This use heating mode can generally be substantially or completely passive, but can optionally be augmented by pump assist depending on the heating requirements. Conversely, the cooling modes can include a first passive charging mode where heat is transferred away from the soil to create a cooling sink by vaporization of liquid in bottom regions of the thermosiphon and condensation of the vapor at the heat exchanger. Condensed and cooled liquid then travels by gravity feed to the bottom regions of the thermosiphon thus cooling surrounding soil. Again, this passive charging mode can often be entirely passive, although pump-assist can be used to augment heat transfer when conditions such as outside winter temperatures or other factors require increased heat transfer rates. The cooling modes can further include a pump-assisted cooling use mode where cooled fluid is drawn up to the evaporator heat exchanger using a pump. Heat is thus transferred from the structure (and heat exchanger) to the chilled lower walls of the thermosiphon. The liquid condensate is then pumped back up to the heat exchanger at a rate determined by the mass flow rate of vapor entering the thermosiphon. A liquid level sensor can be placed above the liquid pump at the bottom of the thermosiphon to monitor this mass flow rate. In each of these four modes, natural convection of heated water in soils surrounding the thermosiphon can be benefit, especially in permeable soils. For example, when heating the ground, convectively driven water surrounding the thermosiphon can cycle as heated water moves upward and draws in cooler nearby water. This convection affect is beneficial as long as flow rates do not drive heated water substantially away from the thermosiphon. Similarly, when charging a heating reservoir, the thermosiphon wall temperature can be driven to over 100° C. sufficient to initiate boiling of water in the soil immediately surrounding the thermosiphon. Vaporized water along the wall can be replenished by capillary action of surrounding water through the soil, e.g. known in other contexts as the heat pipe effect. This can help to reduce near-wall heat transfer limitations between the wall and soil. Insulations below the water table in permeable soils may experience enhanced heat transfer due to flow of ground water if sufficient hydraulic gradients exist.

Optimization of thermosiphon spacing, diameters, patterns and ancillary heat exchangers can greatly benefit from quantitative analysis. The present invention further includes a method of designing a pump-assisted thermosiphon heating or cooling system for heating or cooling a structure consistent with the discussion herein. In particular, the systems of the present invention can involve considerable upfront expense despite significant reductions in operating costs once installed. Therefore, it is important that the system be designed with a capacity sufficient to provide the desired cooling and/or heating. As a result, computer simulations can be very effective in determining ultimate design parameters for a particular project. Generally, design can include acquiring site data such as, but not limited to, ground heat capacity, ambient outdoor temperatures, thermosiphon orientations and locations, and structure square footage. Heat transfer can be calculated as a function of time between the thermal storage material and the structure using the site data to determine heat transfer performance. Based on this information, the pump-assisted thermosiphon heating or cooling system can be built or can be used to revise the site data input into the model in order to optimize the system. Although other approaches can be suitable, Example 3 illustrates one approach consistent with the present invention. A time dependent ambient temperature model can be obtained from the ambient outdoor temperatures. A transient soil temperature distribution can also be calculated using the time dependent ambient temperature model and the thermosiphon model using, for example, ANSYS or TOUGH codes in conjunction with the thermosiphon model.

### EXAMPLES

The following examples illustrate various embodiments of the invention. Thus, these examples should not be considered as limitations of the present invention, but are merely in place to teach how to implement the present invention based upon current experimental data. As such, a representative number of systems are disclosed herein.

### Example 1

### Heat Load Calculation for a Typical Residential House in Utah

The available solar energy in Utah is about 1670 kW-hr/m2/year. Such solar energy at a 70% solar collector efficiency would be about 1169 kWh/m2/year or 4.2 GJ/m2/year. The solar energy was calculated using a solar constant 1.370 kW/m2, annual average of 4.6 kWh/m2/day, monthly average (min in December) of 1.7 kWh/m2/day, and monthly average (max in June) of 7.4 kWh/m2/day.

The following tables represent heating and cooling load calculations based on Salt Lake City, Utah data.

TABLE 1
Heating and Cooling Load Calculation -
Ground-Source Heat Pump Project

| | | Estimate |
|---|---|---|
| Site Conditions | | |
| Nearest location for weather data | | Salt Lake |
| | | City, UT |
| Heating design temperature | ° C. | −11.5 |
| Cooling design temperature | ° C. | 35.1 |
| Average summer daily temperature range | ° C. | 15.0 |
| Cooling humidity level | — | Medium |
| Latitude of project location | ° N | 40.8 |
| Mean earth temperature | ° C. | 12.0 |
| Annual earth temperature amplitude | ° C. | 15.0 |
| Depth of measurement of earth temperature | m | 3.0 |
| Building Heating and Cooling Load | | |
| Type of building | — | Residential |
| Available information | — | Descriptive |
| | | data |
| Building floor area | m² | 150 |
| Number of floors | floor | 2 |
| Insulation level | — | Medium |
| Foundation type | — | Full |
| | | basement |
| Building design heating load | kW | 7.1 |
| | million Btu/h | 0.024 |
| Building heating energy demand | MWh | 8.1 |
| | million Btu | 27.5 |
| Building design cooling load | kW | 11.3 |
| | ton (cooling) | 3.2 |
| Building cooling energy demand | MWh | 22.7 |
| | million Btu | 77.5 |

TABLE 2

| Annual Energy Production | | Estimate |
|---|---|---|
| Heating | | |
| Electricity used | MWh | 3.0 |
| Supplemental energy delivered | MWh | 0.0 |
| GSHP heating energy delivered | MWh | 8.1 |
| | million Btu | 27.5 |
| Seasonal heating COP | — | 2.7 |
| Cooling | | |
| Electricity used | MWh | 5.1 |
| GSHP cooling energy delivered | MWh | 22.7 |
| | million Btu | 77.5 |
| Seasonal cooling COP | — | 4.5 |
| Seasonal cooling EER | (Btu/h)/W | 15.2 |

From Table 1 and Table 2, the annual heating energy for a residential structure can be approximated as: Q_{Heating}=29 GJ, and the annual cooling energy for a residential structure can be approximated as: Q_{Cooling}=82 GJ.

### Example 2

### Thermal Energy Storage Dimensions for One Family House (Simplified Calculation)

Energy recovery efficiency for underground thermal energy storage can be calculated using the dimensions of a soil cylinder holding annual energy load of a typical one family residential house (150 m²×2 floors+basement). This calculation uses the energy calculations from Example 1 (Q_{Cooling}=82×10⁹ J, Q_{Heating}=29×10⁹ J) and assumes the following characteristics of the soil cylinder: η_{E}=0.60, ΔT=15° C., H=10 m, ρcₚ≈2×10⁶ J/m³° C. (damp soil). Using the following equation:

Qₒᵤₜ=η_{E}Qᵢₙ=η_{E}HπR² ρ̅c̅ₚ̅ΔT

the results estimate the R_{Cooling} at about 9.3 m and the R_{Heating} at about 7.2 m. The present calculation shows the feasibility of the structures described herein. Of course, the final dimensions would depend on the specific soil, environment, and heating/cooling demands needed.

### Example 3

As an example, the performance of a set of 7 thermosiphons for freezing soils and the use of frozen soil as an air conditioning heat sink was assessed using a two-dimensional model discussed below. A preliminary model of freezing and thawing of water-saturated soil was created using the commercially available software package COMSOL Multiphysics 3.3. The geometry chosen for the analysis was an array of six thermosiphons placed at the corners of a symmetrical hexagon with a seventh thermosiphon placed at the center of the hexagon. Utilizing the symmetry of the system, a quarter circle with a 5-meter radius was chosen as the domain of interest. Three thermosiphons were modeled in this domain: one positioned centrally and the other two placed 60 degrees apart with one of them on the axis of symmetry. The spacing between thermosiphons was 1.5 meters. Only conduction was modeled in this basic rendition.

An ambient temperature model was used for the external temperatures. This was modeled by a 7-parameter empirical formula determined from 2006 hourly weather data taken from the weather station at Salt Lake City International Airport. This model is a superposition of two sine curves as follows where A through G are the 7 parameters to be adjusted:

Tₒᵤₜ=A+B sin(Ct+D)+E sin(Ft+G)

The independent variable, t, is time (hours). The parameters C and F are the periods of these sine curves and were set to be 2π/24 to represent daily temperature fluctuations and to 2π/8760 to represent yearly seasonal temperature fluctuations, respectively. The other parameters were optimized through a least-square difference method using the solver add-in in Microsoft Excel. These parameters were A=285.3, B=4.60, D=1.62, E=13.44, G=3.19.

The outer edge of the circle was set as a no heat flux, or insulated boundary. The other two boundaries are planes of symmetry, also represented as insulated boundaries.

Thermosiphon interactions with the soil were modeled as modified convective heat flux boundaries. The heat flux was specified as a heat transfer coefficient multiplied by the difference between the temperature in the inside wall of the thermosiphon and ambient temperature.

$${q}_{winter} = {10}^{8} ( \frac{W}{{m}^{2} K} ) \cdot ( {T}_{out} - {T}_{r = {r}_{o}} ) ( K )$$

A highly conductive layer of aluminum 5 mm thick was specified at the edge of each thermosiphon to model the wall. The thermosiphon radius (rₒ) was specified as 5 cm. The heat transfer coefficient on these boundaries was set at 1×10⁸ W/(m²−K) when the temperature of the soil next to the heat pipe was larger than the outside ambient air temperature and to zero when the opposite was true. Although not required, in essence, with that large of a heat transfer coefficient, the heat flux during the winter season was modeled as if the temperature of the inside of the heat pipe is the same as external air temperature.

After the winter season was simulated and results were obtained, the heat flux was integrated over boundary surfaces and all time steps to obtain the total heat transferred from the system per length of heat pipe. This was found to be 2.65×10⁵ kJ/m of thermosiphon. The air conditioning load was arbitrarily determined to be 85% of the heat transferred from the soil, which is 2.25×10⁵ kJ/m. The heat transfer coefficient was calculated by integrating the difference between the ambient temperature function and the indoor temperature for all T greater than 295 K over the course of the year and dividing this along with the circumference of the heat pipe into the total load of 2.25×10⁵ kJ/m:

$$h ( \frac{W}{{m}^{2} \cdot K} ) = \frac{2.25 \times {10}^{8} \frac{J}{m}}{3600 \frac{s}{hr} \cdot 2 π \cdot r \cdot {\int }_{0}^{8760} ( {T}_{out} - 295 ) d t} = 28.45 \frac{W}{{m}^{2} \cdot K}$$

Thus, the summer season heat flux into the soil is modeled as:

$${q}_{summer} = 28.45 ( \frac{W}{{m}^{2} K} ) \cdot ( {T}_{out} - 295 ) ( K )$$

with an overall heat transfer coefficient of 28.45 W/(m²K) and a temperature difference based on the living space temperature being cooled to 295 K (71° F.), and where Tₒᵤₜ is the outside temperature modeled by the ambient temperature model. Using that overall heat transfer coefficient, estimates of the total number and lengths of the thermosiphons can be obtained for a specified cooling application.

The equation solved for the temperatures in the subdomain is:

$$ρ \cdot {C}_{p} \cdot \frac{\partial T}{\partial t} + ∇ \cdot ( - k ∇ T ) = Q$$

In this situation, there is no heat source in the subdomain, so Q=0. The isotropic thermal conductivity, k, is modeled as a function of temperature:

$$k = 0.0015 \cdot T + 0.7489 - \frac{1.16}{π} {tan}^{- 1} ( 1000 \cdot ( T - 272.5 ) )$$

The inverse tangent smoothes the transition that occurs during the phase change of water to ice. The subdomain was modeled as soil with 35% porosity. Therefore, the soil density can be taken as a volume weighted average of the density of water, 1000 kg/m³, and the density of soil, 2650 kg/m³:

ρ=0.35·ρ_{liquid}+0.65·ρ_{solid}

Also, the heat capacity, Cₚ, can be modeled as a weighted average of the product of densities and heat capacities divided by the overall density:

$${C}_{p} = \frac{0.35 \cdot {ρ}_{liquid} \cdot {C}_{p , liquid} + 0.65 \cdot {ρ}_{solid} \cdot {C}_{p , solid}}{ρ}$$

Where the heat capacity of the soil, C_{p,solid}=1003.2 J/(kg K) and the heat capacity of the water is a function of temperature that includes the phase change and the heat of fusion of ice (spread over ˜0.2 degrees centered at 273.15 K):

$${C}_{p , liquid} ( \frac{J}{kg \cdot K} ) = 1.65 \times {10}^{6} exp ( \frac{- {( T - 273.15 )}^{2}}{0.0128} ) + 3100 + 700 \cdot {tan}^{- 1} ( 1000 \cdot ( T - 273.15 ) )$$

The initial temperature of the domain was set at 15° C. (53.3° F.). The simulation starts and ends on October 15. The model was run for the full year.

The absolute minimum (17° F.) occurs in January next to the wall of the heat pipe. The maximum temperature that occurs next to the heat pipe during the summer season does not exceed initial conditions. As can be seen, the soil between the heat pipes freezes during the winter and remains frozen throughout the summer and into September. Extrapolating these results to a typical family home, it is estimated that the cooling needs could be met with 28 thermosiphons using the same spacing.

The results of this example also allow comparisons of the heat transfer to and from thermosiphons with the conventional technology of looped tubing in boreholes. A comparison of the results obtained in this simulation was made to results obtained for a design of a ground loop heat exchanger by Spitler in his software package GLHEPro. The example that Spitler uses in this design tool has a total cooling load of 95.600 MW-hr. GLHEPro indicates that for this load, 3796.7 meters of borehole would be required. This corresponds to 25 kWh of load per meter of borehole. In comparison, the results obtained from this simulation show a load of 62.4 kWh per meter of thermosiphon which is a 250% increase in heat transfer. In other words, ground loop heat exchangers typical of common practice requires 2.5 times the amount of drilling depth of thermosiphon technology for the same heat transfer.

It is to be understood that the above-referenced arrangements are only illustrative of the application for the principles of the present invention. Numerous modifications and alternative arrangements can be devised without departing from the spirit and scope of the present invention. While the present invention has been shown in the drawings and fully described above with particularity and detail in connection with what is presently deemed to be the most practical and preferred embodiment(s) of the invention, it will be apparent to those of ordinary skill in the art that numerous modifications can be made without departing from the principles and concepts of the invention as set forth herein.

What is claimed is:

1. A system for heating or cooling a structure, comprising:
a) a thermosiphon in thermal communication with a thermal storage material, said thermosiphon being partially filled with a heat transfer fluid;
b) a heat exchanger operatively connected to the thermosiphon and in thermal communication with the structure such that thermal energy can be transferred between the thermal storage material and the structure; and
c) a fluid transfer device fluidly associated with the heat transfer fluid and configured to draw the heat transfer fluid towards the heat exchanger.

2. The system of claim 1, wherein the thermosiphon further comprises an evaporating region and a condensing region, said heat transfer fluid being present in a liquid and vapor phase, and is in thermal communication with the thermal storage material such that the heat transfer fluid is capable of transferring energy between the thermal storage material and the evaporating region or the condensing region.

3. The system of claim 2, wherein the heat transfer fluid is selected from the group consisting of water, R134a, ammonia, ethanol, condensed hydrocarbon gasses, sodium, and mixtures thereof.

4. The system of claim 2, further comprising a secondary storage area operatively connected in a by-pass configuration to the heat exchanger and wherein the fluid transfer device transfers the heat transfer fluid from the thermosiphon to the secondary storage area.

5. The system of claim 4, further comprising a second fluid transfer device fluidly connected between the secondary storage area and the heat exchanger.

6. The system of claim 1, further comprising a charging heat exchanger operatively connected to the thermosiphon and oriented outside the structure such that thermal energy can be transferred between the thermal storage material and the charging heat exchanger sufficient to charge the thermal storage material.

7. The system of claim 6, further comprising a heat transfer barrier system operatively connected between the thermal storage material and each of the heat exchanger and the charging heat exchanger and which can selectively direct heat transfer to or from either of the heat exchanger and the charging heat exchanger.

8. The system of claim 2, wherein the heatsink is a cooling reservoir having an effective heat capacity greater than about 10,000,000 kJ.

9. The system of claim 8, wherein the heat exchanger is an evaporator.

10. The system of claim 2, wherein the system is configured to heat the structure and the heat exchanger is a heat radiator.

11. The system of claim 10, wherein the heatsink is a heating reservoir having an effective heat capacity greater than about 30,000,000 kJ.

12. The system of claim 1, wherein the storage material is a volume of earth.

13. A system for cooling and heating a structure, comprising:
a) a cooling system in thermal communication with the structure, said cooling system comprising:
i) a first thermosiphon in thermal communication with a first thermal storage material, said first thermosiphon being partially filled with a first heat transfer fluid;
ii) a first heat exchanger operatively connected to the first thermosiphon and in thermal communication with the structure such that thermal energy can be transferred between the first thermal storage material and the structure; and
iii) a first fluid transfer device fluidly associated with the first heat transfer fluid and configured to draw the first heat transfer fluid towards the first heat exchanger; and
b) a heating system in thermal communication with the structure, said heating system comprising
i) a second thermosiphon in thermal communication with a second thermal storage material, said second thermosiphon being partially filled with a second heat transfer fluid;
ii) a second heat exchanger operatively connected to the second thermosiphon and in thermal communication with the structure such that thermal energy can be transferred between the second thermal storage material and the structure; and
iii) a second fluid transfer device fluidly associated with the second heat transfer fluid and configured to transfer the second heat transfer fluid within the second thermosiphon.

14. The system of claim 13, wherein the first and second thermosiphons further comprise evaporating regions and condensing regions, said first and second heat transfer fluids present in a liquid and vapor phase, and are in communication with the first and second thermal storage materials, respectively, such that the first and second heat transfer fluids are capable of transferring energy between the first and second thermal storage materials and the evaporating regions or the condensing regions, respectively.

15. The system of claim 14, wherein the second fluid transfer device transfers the second heat transfer fluid from the condensing region to the evaporating region.

16. The system of claim 13, further comprising a secondary storage area operatively connected in a by-pass configuration to the first heat exchanger and wherein the first fluid transfer device transfers the first heat transfer fluid from the first thermosiphon to the secondary storage area.

17. The system of claim 13, further comprising a first charging heat exchanger operatively connected to the first thermosiphon and a second charging heat exchanger operatively connected to the second thermosiphon, wherein each charging heat exchanger is oriented outside the structure such that thermal energy can be transferred between the first thermal storage material and the first charging heat exchanger sufficient to charge the first thermal storage material and such that thermal energy can be transferred between the second thermal storage material and the second charging heat exchanger sufficient to charge the second thermal storage material.

18. A method of energy transfer between a structure and outside the structure, comprising:
a) charging a thermal storage material by forming a thermal gradient between the structure and the thermal storage material using a thermal transfer fluid; and
b) transferring thermal energy between the structure and the thermal storage material using a thermosiphon containing the thermal transfer fluid, wherein at least one of the steps of charging and transferring is augmented using a fluid transfer device.

19. The method of claim 18, wherein the thermosiphon further comprises an evaporating region and a condensing region, said heat transfer fluid being present in a liquid and vapor phase, and is in thermal communication with the thermal storage material such that the heat transfer fluid is capable of transferring energy between the thermal storage material and the evaporating region or the condensing region.

20. The method of claim 18, wherein charging the thermal storage material occurs during winter months thereby creating a cooling reservoir, and wherein transferring thermal energy from the structure to the cooling reservoir results in cooling the structure.

21. The method of claim 18, wherein charging the thermal storage material occurs during summer months thereby creating a heating reservoir, and wherein transferring thermal energy from the heating reservoir to the structure results in heating the structure.

22. A method of designing a pump-assisted thermosiphon heating or cooling system for heating or cooling a structure, comprising the steps of:
a) acquiring site data including at least ground heat capacity, ambient outdoor temperatures, thermosiphon orientations, and structure square footage;
b) calculating heat transfer as a function of time between a thermal storage material and the structure using the site data to determine heat transfer performance;
c) using the heat transfer performance to build the pump-assisted thermosiphon heating or cooling system or to revise the site data.

23. The method of claim 22, wherein the calculating includes providing a time dependent ambient temperature model from the ambient outdoor temperatures, determining a thermosiphon model, and calculating a transient soil temperature distribution using the time dependent ambient temperature model and the thermosiphon model.

24. The method of claim 22, wherein the pump-assisted thermosiphon is a heating system.

25. The method of claim 22, wherein the pump-assisted thermosiphon is a cooling system.
